(19) United States
(12) Patent Application Publication
(10) Pub. No.: US 2026/0055351 A1
(43) Pub. Date: Feb. 26, 2026

(54) METHODS AND SYSTEMS FOR PRODUCING IMPROVED FERMENTED BEVERAGE CONCENTRATE

(71) Applicant: Sustainable Beverage Technologies Inc., Golden, CO (US)

(72) Inventors: Patrick J. TATERA, Talkeetna, AK (US); Raphael BROH, Denver, CO (US)

(21) Appl. No.: 19/140,884

(22) PCT Filed: Dec. 20, 2022
(86) PCT No.: PCT/US2022/082066

§ 371 Date: Jun. 18, 2025

(51) Int. Cl. C12C 11/11; A23F 3/16; C12C 11/00; C12G 1/022; C12H 3/04

(52) U.S. Cl. CPC C12C 11/11; A23F 3/166; C12C 11/003; C12G 1/0203; C12H 3/04; C12G 2200/05

(57) ABSTRACT

A system and method for improved fermented beverage concentrate is described. One embodiment includes a method for producing a fermented beverage concentrate, the method comprising: fermenting a first fermentable aqueous product to produce a base product; and performing a nesting process on the base product, wherein the nesting process comprises: a concentration phase wherein at least a portion of the base product is passed through a separation system and a retentate is returned to the base product to produce a nesting solution, a water nest wherein water is added to at least a portion of the nesting solution and passed through the separation system, and a fermentable aqueous product nest wherein a second fermentable aqueous product is added to at least a portion of the nesting solution and passed through the separation system to increase the concentration of the nesting solution.

### CROSS-REFERENCE TO RELATED APPLICATION

This application incorporates by reference commonly owned and assigned U.S. Pat. No. 8,889,201, including particularly the description of systems and methods for a nested approach to producing a fermented beverage concentrate that is contained therein.

### FIELD OF THE INVENTION

The present invention relates to systems and methods for the production of fermented beverages. In particular, but not by way of limitation, the present invention relates to systems and methods for making fermented beverage concentrate.

### BACKGROUND OF THE INVENTION

As used herein, the terms “fermented beverage” and “fermented beverages” refer to beverages—such as beer, wine, cider, sake, and kombucha—where the consumable product is commonly understood as the product following the fermentation process. In this respect, as used herein, the terms “fermented beverage” and “fermented beverages” do not include distilled liquors (such as vodka, gin, soju, rum, whisky, tequila, brandy, etc.) or the like, where the solution that is produced by fermentation is just an intermediate solution that still requires distillation before it would be considered the consumable product. For fermented beverages, the alcohol by volume (ABV) of the consumer product is typically limited by what can be tolerated by the yeast. For distilled liquors, the ABV is intentionally increased in order to create a consumable product with higher alcohol content. Unlike distilled liquors, where the higher ABV is commonly viewed as a desired property of the beverage, for many fermented beverages it is often desirable to have a consumable product with lower ABV, such as non-alcoholic beer, non-alcoholic kombucha wine, non-alcoholic kombucha, non-alcoholic sake, and non-alcoholic cider. Note that the term “non-alcoholic” is not limited to beverages with no alcohol. Instead, the term “non-alcoholic” includes beverages with an ABV that is under a defined threshold. For example, in the United States the term “non-alcoholic” is often used to describe malt beverages that contain up to 0.5% ABV. (See, e.g., 27 C.F.R. § 7.71 (“(e) Non-alcoholic. The term “non-alcoholic” may be used on malt beverages, provided the statement ‘contains less than 0.5 percent (or 0.5%) alcohol by volume’ appears in direct conjunction with it, in readily legible printing and on a completely contrasting background.”).)

One of the factors during the production of fermented beverages is the alcohol produced during fermentation. While the alcohol is sometimes a desired byproduct of fermentation, alcohol can inhibit or limit the fermentation process. For example, during the production of beer, one of the byproducts of fermentation is diacetyl. Diacetyl is often considered an undesired byproduct. While yeast produce diacetyl, yeast will also later consume diacetyl. However, if the alcohol by volume gets too high, it may limit the yeasts ability to remove undesired byproducts like diacetyl.

In addition, alcohol can limit the ability to produce a fermented beverage concentrate. Given the high water-content-by-volume of fermented beverages, it may be desirable to produce a fermented beverage concentrate in order to improve transportability (e.g., decrease transportation costs and/or make it less difficult to enjoy these beverages during outdoor activities like hiking trips or camping). As used herein, the term “fermented beverage concentrate” refers to a solution that requires water, alcohol, or some other diluting agent to be added to be at the desired concentration or gravity for consumer consumption. For example, a fermented beverage concentrate that is at twice the concentration of the consumer product would require one part diluting agent (e.g., water, alcohol, a combination of water and alcohol, etc.) to every 1 part fermented beverage concentrate to make the consumer product. Likewise, a fermented beverage concentrate that is at three times concentration would require 2 parts diluting agent (e.g., water, alcohol, or a combination of water and alcohol) to every 1 part fermented beverage concentrate to make the consumer product. When referring to fermented beverage concentrate, the word “concentrate” refers primarily to the gravity or concentration of the non-alcohol ingredients. For example, as will be apparent from the preset disclosure, a fermented beverage concentrate could have a low (not concentrated) alcohol content. Indeed, one of the advantages of the present invention is that it allows for the production of fermented beverage concentrate that is particularly well suited for producing non-alcoholic beverages.

In order to make non-alcoholic fermented beverages and/or fermented beverage concentrate, the industry has focused on prior art solutions of deconstructing the beer, such as removing water before shipping, and then reconstituting the beverage at its destination to reach the desired concentration. For example, multiple old and recent disclosures (e.g., Schutter et al., WO2016083482 Al, “Beer or cider concentrate,” (Anheuser-Busch Inbev S.A.); Peterson et al., US 2016/0230133, “Alcoholic Beverage Concentrate Process,” (Keurig Green Mountain, Inc.); Thijssen, U.S. Pat. No. 4,265,920, “Process for concentration of alcoholic beverages,” (Douwe Egberts); Tokuda et al., US 2008/0063749, “Mead making method”; etc.) focus on a deconstruction approach, where the fermented beverage is processed after it has been brewed to completion, and it is broken down into separate components. Using this deconstruction approach, a fermented beverage (such as beer) can be processed through a separation step to separate it into a permeate stream (substantially comprising water, aroma, and alcohol), and a retentate stream (substantially comprising flavoring components, aroma, some alcohol, and some water). In certain instances, the permeate stream is then processed to further remove alcohol and aromatics from the permeate so that they can be returned to the retentate. This further processing of the permeate stream is typically done using processes such as freeze concentration or distillation. There are many problems with a deconstruction approach. The process requires that the fermented beverage be brewed completely (or near completely) in advance of the concentration processing, thus the concentration processing becomes an added set of steps to the brewing process. This adds time and hence reduces production capacity. In addition, the added equipment costs in deconstruction approaches can be substantial (e.g., distillation and freeze concentration equipment), and it may require specialized permits (distillation permits) depending on the brewing location. Moreover, deconstruction approaches also open up a potentially damaging processing activity (post fermentation) that can expose the fragile finished fermented beverage to the effects of damaging oxidation or microbial contamination and therefore reduce shelf stability of the finished product.

In order to address some of the problems with the prior art, one inventive approach is to use a nested fermentation process to build a higher concentrate beverage. For example, in U.S. Pat. No. 8,889,201 the present applicant taught inventive systems and methods for nested fermentation. In contrast to the deconstruction approach, the nested fermentation process is a constructional approach where the finished fermented beverage concentrate is a result of building the final level of flavor concentration through one or more additive steps. This is advantageous because it reduces the necessary residence time of the beverage within the fermentation vessel, relative to the amount of servable product produced, therefore increasing the production capacity of the equipment, which is a further asset to the producer. Thus, the fermented beverage concentrate is an outcome of construction, rather than deconstruction and re-assembly. For example, one of the benefits of the nested fermentation process is that it allows the fermented beverage concentrate to finish in the same stable oxidative state, or low-dissolved oxygen state, as with traditional, non-concentrated approaches. The fermented beverage concentrate will then degrade at the same rate as traditionally produced fermented beverages. However, because the fermented beverage concentrate is diluted for serving, the degradative flavors are also diluted. Thus, the fermented beverage concentrate can exist in its concentrated, non-diluted form for a longer time than traditional, non-concentrated beverages before degradative effects reach unacceptable flavor threshold levels in the finished consumer beverage.

Although present devices are functional, they are not sufficiently accurate or otherwise satisfactory. Accordingly, a system and method are needed to address the shortfalls of present technology and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a system and method for producing fermented beverage concentrate. In various exemplary embodiments, the present invention can include a method for producing a fermented beverage concentrate, the method comprising: fermenting a first fermentable aqueous product to produce a base product; and performing a nesting process on the base product, wherein the nesting process comprises: a water nest wherein water is added to at least a portion of the base product and passed through a separation system to produce a nesting solution, and a fermentable aqueous product nest wherein a second fermentable aqueous product is added to at least a portion of the nesting solution and passed through the separation system to increase the concentration of the nesting solution. In some embodiments, the nesting process may further comprise a concentration phase wherein at least a portion of the nesting solution is passed through the separation system to increase the concentration of the nesting solution and/or a finishing nest wherein fermentation ingredients are added to the nesting solution without further passing the nesting solution through the separation system. In addition, in various embodiments fermenting the first fermentable aqueous product comprises using a first yeast and wherein the finishing nest comprises using a second yeast, wherein the first yeast and second yeast are different. In another embodiment, the first and second yeasts could be the same. In other embodiments, the method further comprises removing solids from the base product prior to the nesting process. Those skilled in the art will understand that the first and second fermentable aqueous product may comprise worts that are the same or different.

In additional exemplary embodiments the present invention covers a method for producing a fermented beverage concentrate, the method comprising: fermenting a first fermentable aqueous product to produce a base product; and performing a nesting process on the base product, wherein the nesting process comprises: a concentration phase wherein at least a portion of the base product is passed through a separation system and a retentate is returned to the base product to produce a nesting solution, a water nest wherein water is added to at least a portion of the nesting solution and passed through the separation system, and a fermentable aqueous product nest wherein a second fermentable aqueous product is added to at least a portion of the nesting solution and passed through the separation system to increase the concentration of the nesting solution.

In additional exemplary embodiments the present invention covers a method for producing a fermented beverage concentrate, the method comprising: performing a first fermentation to produce a nesting solution; reducing the alcohol by volume (ABV) of the nesting solution, wherein reducing the ABV comprises forming a first combined solution by combining at least a portion of the nesting solution with water, passing the first combined solution through a separation system and returning the retentate to the nesting solution; and increasing the concentration of the nesting solution, wherein increasing the concentration comprises forming a second combined solution by combining at least a portion of the nesting solution with a fermentable aqueous product, passing the second combined solution through the separation system and returning the retentate to the nesting solution. In various embodiments, performing the nesting process may further comprise passing at least a portion of the nesting solution through a separation system and returning the retentate to increase the concentration of the nesting solution, and/or adding fermentation ingredients to the nesting solution without further passing the nesting solution through the separation system. The present invention teaches that depending on the desired product, the fermentable aqueous product may comprise one of wort, must, sweetened tea, or brewers crystals. In some embodiments, reducing the ABV of the nesting solution comprises reducing the ABV to 1% or lower, to 0.75% or lower, to 0.50% or lower, or to 0.25% or lower. In various embodiments, increasing the concentration of the nesting solution comprises increasing the concentration of the nesting solution to greater than 2.0 times, 3.0 times, 4.0 times, 5.0 times, 6.0 times, 7.0 times, or 8.0 times the concentration of a desired concentration of a final consumed product.

In additional exemplary embodiments the present invention covers a method for producing a fermented beverage concentrate, the method comprising: performing a first fermentation to produce a base product; concentrating the base product to produce a nesting solution, wherein the concentrating comprises passing at least a portion of the base product through a separation system and returning the retentate; reducing the ABV of the nesting solution, wherein reducing the ABV comprises forming a first combined solution by combining at least a portion of the nesting solution with water, passing the first combined solution through a separation system and returning the retentate to the nesting solution; and performing a second fermentation using the nesting solution, wherein performing the second fermentation comprises adding fermentation ingredients to the nesting solution.

In other embodiments, the present invention includes a nesting system for producing fermented beverage concentrate, the system comprising: a nesting tank for holding a nesting solution; an output of the nesting tank that is connected to an input to a separation system; the separation system comprising: a series of filters, wherein at least one filter in the series of filters has increasingly selective filtration as compared to a prior filter in the series of filters; a retentate output that is connected to an input to the nesting tank, wherein the retentate output carries retentate from the series of filters. The series of filters may comprise a series of membranes, and in one embodiment may comprise one or more nano-filtration membranes, and one or more reverse osmosis membranes. The separation system may further comprise a permeate output that carries permeate from the series of filters. This permeate may be recovered and optionally used.

In yet other embodiments, the present invention includes a method of rinsing hops used during beer production, the method comprising: producing a beer concentrate; including hops in the beer concentrate; separating the hops from the beer concentrate; rinsing the hops that were removed from the beer concentrate, and recovering the liquid used to rinse the hops. In some embodiments the hops are added during the process of producing the beer concentrate, while in other embodiments the hops are added to the beer concentrate after the beer concentrate is fully fermented.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIGS. 1A-1C depict exemplary systems and methods consistent with embodiments of the present invention, including an exemplary system and process for preparing a base product (FIG. 1A) and an exemplary system and process for nested fermentation (FIGS. 1B-1C).

FIG. 2 is an exemplary diagram of a separation system consistent with embodiments of the present invention.

FIG. 3 is an exemplary diagram of a nesting system consistent with embodiments of the present invention.

FIG. 4 depicts an exemplary system and method for nested fermentation consistent with embodiments of the present invention.

FIGS. 5A-5B depict exemplary systems and methods consistent with embodiments of the present invention, including an exemplary system and process for preparing a base product (FIG. 5A) and an exemplary system and process for nested fermentation (FIG. 5B).

FIG. 6 is an exemplary diagram of a process for making a beer concentrate consistent with embodiments of the present invention, with potential outputs of each process step.

### DETAILED DESCRIPTION

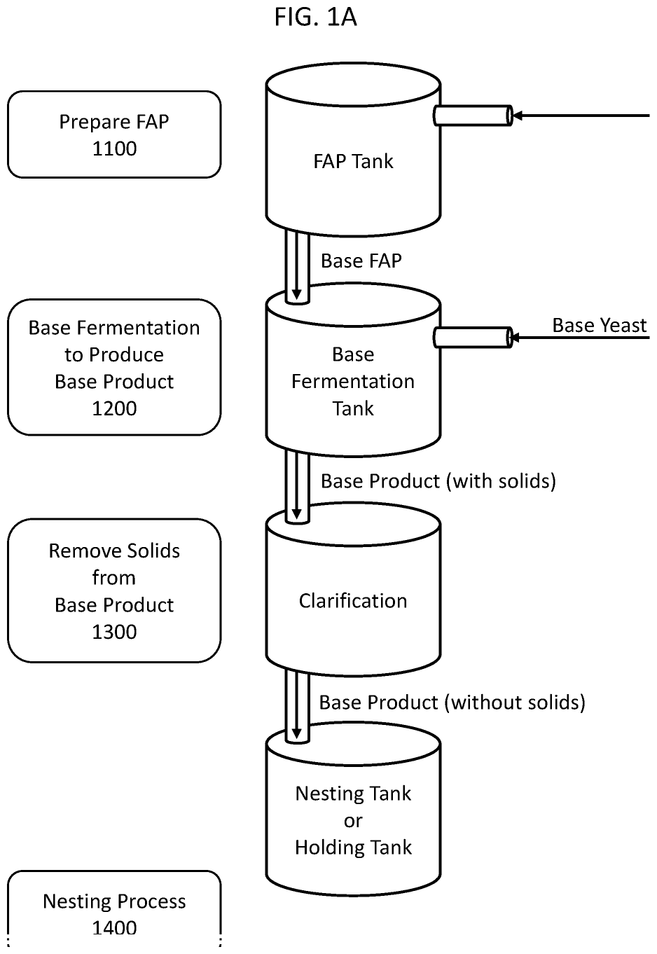

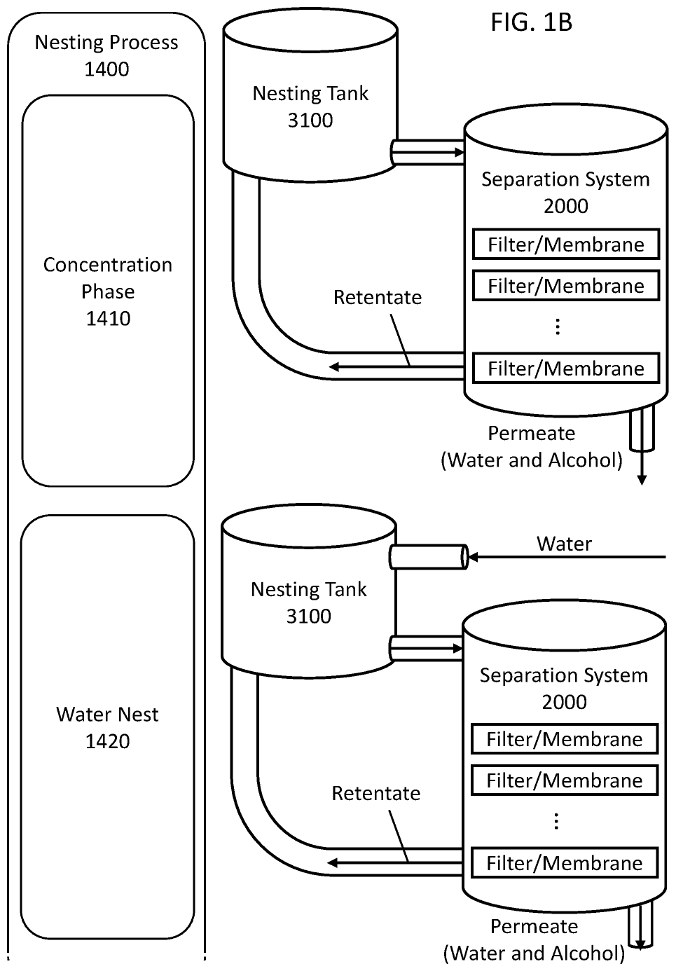

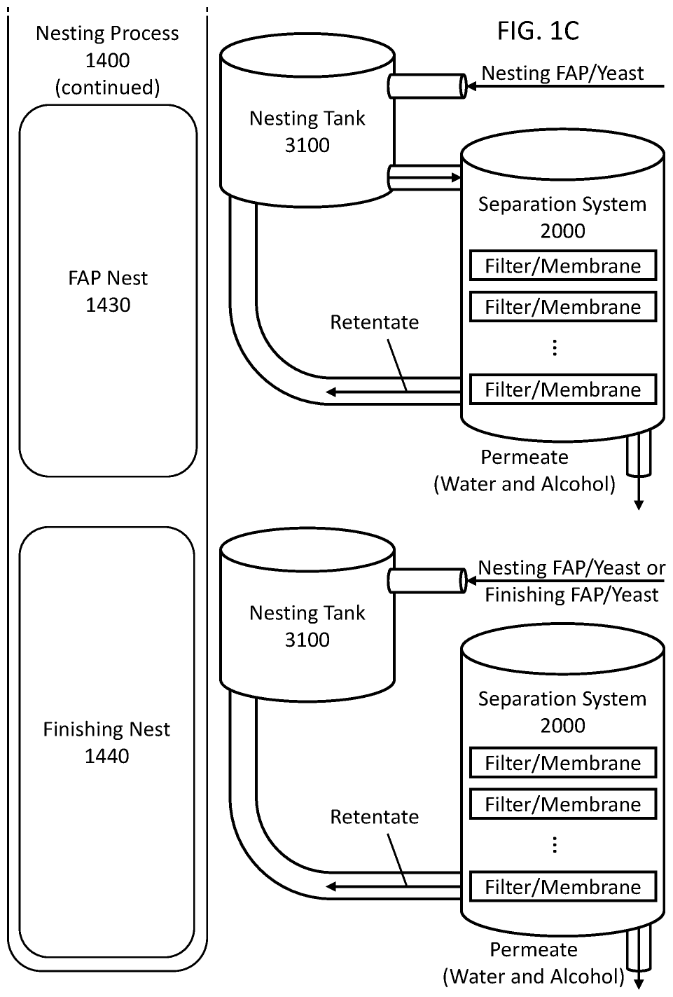

Referring now to the drawings, where like or similar elements are designated with identical reference numerals throughout the several views, and referring in particular to FIG. 1, it illustrates a system and method for producing a fermented beverage concentrate. For purposes of explanation, certain figures show method steps along with an exemplary corresponding system diagram. A person of skill in the art would understand that the method steps are not limited by the system diagram. For example, some of the illustrated embodiments depict using multiple different tanks for different process steps. A person of skill in the art, however, would understand that the same tank—or no tank at all—may be used to accomplish the same function.

### Production of Fermentable Aqueous Product (FAP)

FIG. 1A starts with the preparation of the fermentable aqueous product (FAP), marked as 1100. Fermented beverages are commonly based on an aqueous product that contains sugars that are consumed during the fermentation process. For example, for beer production the FAP is often referred to as the “wort”—which is an aqueous product comprising malt extract (from grain mash) and water. For wine production, the FAP is often referred to as the “must”—which is an aqueous product comprising fruit juice (typically from grapes) as well as the pomace (solid portions of the fruit, including skins, seeds, stems, etc.). For kombucha, sweetened tea is often used as the FAP. Those of skill in the art will readily understand what the FAP is for various fermented beverages.

For the present invention, production 1100 of the FAP may be done using traditional methods and known processes. FIG. 1A shows the FAP being prepared in a FAP tank, but those skilled in the art will recognize this is in no way limits the present invention. For example, the production of wort for beer—including steps such as mashing, lautering, boiling, separation, and cooling—is well understood by those skilled in the art and the method steps and system options for producing wort are well understood in the field. Likewise, the various options for producing must for wine, sweetened tea for kombucha, etc., is well understood by those skilled in the art.

In addition, although not required for the present invention, those of skill in the art will understand (from the description herein) that systems and methods consistent with the present invention may benefit from using a FAP that has a higher concentration (or higher gravity) than what is used for typical or traditional processes. For example, for beer production if a typical wort is capable of being used to produce a number N of consumable 12 ounce beers, systems and methods consistent with the present invention may benefit from using a concentrated wort that is capable of being used to produce a number of consumable 12 ounce beers that is a multiple of N, where the multiple is typically in the range of 1.05 N to 1.75 N. Likewise, for kombucha production the present invention may use a higher amount of sugar and tea for forming the sweetened tea FAP.

In addition, although not required for the present invention, those of skill in the art will understand that one of the benefits of the present invention is that it allows the use of the same FAP during different fermentation steps (base fermentation 1200, FAP nest 1430, and/or and finishing fermentation 1440, discussed below) or different FAP during one or more different steps, including a “base” FAP used during the base fermentation 1200, a “nesting” FAP used during the nesting FAP process 1430, and a “finishing” FAP used during the final fermentation 1440. For many fermented beverages produced according to the present invention, the fermentation during nesting 1430 and/or finishing fermentation 1440 have a greater impact on attributes such as flavor, aromatics, and mouth feel. Accordingly, a brewer may desire to use specific yeasts (that may be less common and often more expensive) during nesting and/or final fermentation to achieve these desired attributes (as discussed herein). Likewise, as discussed herein, a brewer may desire to use more efficient (economically and operationally) fermentable products for the nested and/or finishing fermentation 1430/1440.

For example, for the production of beer, the base wort, nesting wort, and finishing wort can be the same wort or different worts. Depending on the beer being produced, brewers may desire to use the same wort for the base fermentation, nesting, and finishing fermentation or a specific “base” wort for the base fermentation 1200, a specific nesting wort for nesting 1430, and/or a specific finishing wort for the finishing fermentation 1440. In some cases, the base wort may be selected because it uses less expensive ingredients. In other cases, the base wort may be selected because it uses a malt extract that produces a more stable base for the nesting process 1400. The nesting and finishing worts, which may be the same or different, may also be more efficient (economically and operationally) products such as brewers crystals.

### Base Fermentation

As shown in FIG. 1A, the FAP is used for a base fermentation 1200. During the base fermentation 1200, the FAP is fermented to produce a base product for the nesting process 1400. During the base fermentation process 1200, sugars in the FAP are converted to metabolic byproducts such as alcohol and carbon dioxide.

The primary purpose of the base fermentation step 1200 is to produce a base product for the nesting process 1400. As discussed herein, because the nesting process 1400, including the FAP and/or finishing nest 1430/1440 have a greater impact on attributes such as taste, aromatics, and mouth feel, the base fermentation step 1200 can be less concerned with these properties. Similar to the discussion above regarding the FAP, systems and methods of the present invention may also benefit from using the same or different yeasts for the base fermentation 1200 (a base fermentation yeast), nesting 1430 (a nesting yeast), and finishing fermentation 1440 (a finishing fermentation yeast).

Given the reduced concern regarding attributes such as flavor and aromatics during the base fermentation process 1200, systems and methods consistent with the present invention may differ from traditional processes in that they can use fermentable aqueous products with a higher concentration (or gravity) and in that they may be performed over an shorter time period. In addition, because the overall goal of the invention is to produce a fermented beverage concentrate, it is preferred that the base fermentation process 1200 produce a base product with a higher density than the desired density of the consumed product. The density of the base product may depend, in part, on the desired density of the final fermented beverage concentrate. For example, if the overall goal is to produce a fermented beverage concentrate that is 8 times the density of the consumed product, it may be desirable for the base fermentation step 1200 to produce a base product that is approximately 1.5-2 times the density of the consumed product. If the overall goal is to produce a fermented beverage concentrate that is 6 times the density of the consumed product, it may be desirable for the base fermentation step 1200 to produce a base product that is approximately 1.25-1.75 times the density of the consumed product. In yet further embodiments, it may be desirable for the fermentation step 1200 to produce a base product that is 1.05-3.0 times the density of the consumed product. A base product that is greater than 3 times the density of the consumed product is not excluded from the scope of the present invention.

Turning to an example for beer production, one of the primary goals of base fermentation 1200 is to convert the sugars in the wort to alcohol in order to form a beer base for the nesting process 1400. Given the processing involved during the nesting process 1400, those of skill in the art will recognize that the creation of aromatics and more complex flavor components in the beer base are not as important, and in many cases aromatics and other components are not desired. Accordingly, the focus of the base fermentation process 1200 can be to convert sugars to alcohol and not producing aromatics. A base fermentation yeast may be selected to reduce cost, improve efficiency, and/or produce a more stable base beer.

In addition, and as discussed above, it can be advantageous to use base wort at higher density or higher gravity (e.g., a wort capable of producing 1.05-2.0 times the number of consumable beers as compared to a traditional wort) in order to achieve a beer base with a higher density than the beer a consumer would drink. For example, if the overall goal is to produce a beer concentrate that is 6 times the density of a consumer beer, a brewer would control the base fermentation step 1200 to create a base beer that is 1.25-1.75 times the density of a consumer beer. If the overall goal is to produce a beer concentrate that is 4 times the density of a consumer beer, a brewer would control the base fermentation step 1200 to create a base beer that is 1.1-1.6 times the density of a consumer beer.

Removing Solids from the Base Product

Prior to the nesting process 1400, it is preferred that the base product be processed in order to remove undesired solids. For example, as shown in FIG. 1A, a base product (with solids) may be passed through a clarification system (such as a centrifuge, filter, or settling tank) in order to separate the liquid from the undesired solids. The output is a base product (without solids) that is more optimal for the nesting process 1400. For the example of beer production, undesired solids such as yeast, trub, and vegetative matter will be removed. For the example of wine production, undesired solids such as yeast and vegetative matter will be removed. For the example of kombucha, undesired solids such as micro-biological organisms (scobe) and vegetative botanical matter will be removed. For the example of wine, undesired solids such as fruit solids and yeast solids will be removed. For the example of sake, undesired solids such as fruit solids, rice solids, yeast solids, or Koji solids will be removed. Those of skill in the art will be readily aware of the undesired solids for different fermented beverages, and the various options for separating the liquid and undesired solids.

### Nesting Process and Finishing Fermentation

Preferably after the solids are removed from the base product, the base product is passed to the nesting system where it undergoes a nesting process 1400.

The nesting process can include four general phases: a “concentration phase” 1410 to increase the concentration of the solution, a “water nest” 1420 to reduce the ABV of the solution, a “FAP nest” 1430 to further increase concentration and develop finishing attributes, such as flavor, aroma, and mouth-feel, and a “finishing nest” 1440 to condition the solution. For illustrative purposes, these four general phases are shown in FIGS. 1B-1C with an exemplary system diagram. As explained herein, these phases are not strictly linear, nor are these phases exclusive of one another. For example, while the concentration phase 1410 and water nest 1420 will generally be performed before the finishing nest 1440, those of skill in the art will realize that the concentration phase 1410 and water nest 1420 may be performed separately, together, and in different overlapping or non-overlapping orders. In addition, all four phases may not be required for certain processes and products.

### Concentration Phase

The nesting process 1400 generally begins with a base product that preferably has been separated from undesired solids. For simplicity of reference, once this base product starts to undergo the nesting process, the solution will be referred to as the nesting solution. For the concentration phase 1410, the base product (now nesting solution) is passed through a separation system 2000 in order to remove alcohol and water to both decrease the alcohol by volume (ABV) and increase the concentration of the nesting solution. In FIGS. 1A and 1B it indicates the base product is passed to the nesting tank prior to going into the separation system. Those of skill in the art, however, will understand that the base product may be passed directly to the separation system without first going into the nesting tank. Alternatively, a portion of the base product could go directly to the separation system and a portion to the nesting tank. In addition, those of skill in the art will understand that some alternative holding tank could be used between the clarification step 1300 and the nesting process 1400.

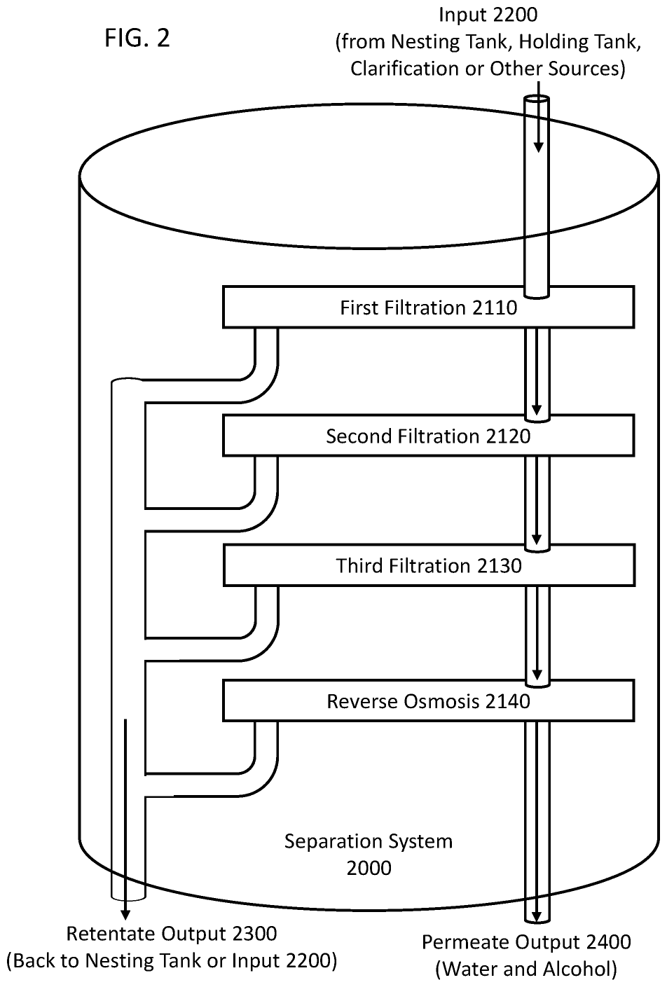

The separation system is a system comprising one or more filters and/or one or more membranes that helps separate the nesting solution into a permeate (substantially comprising water and alcohol), and retentate (substantially comprising flavoring components, aroma, some alcohol, and some water). In certain embodiments, the separation system may comprise a series of filters and/or membranes. The series of filters and/or membranes may be used to reduce the osmotic pressure on each filter/membrane while still effectively separating certain portions of the solution (water and alcohol) while retaining others (comprising flavoring components, aroma, some alcohol, and some water). In the example in FIG. 2, the separation system 2000 comprises a cascaded filter 2100 comprising a series of membranes (2110, 2120, 2130, 2140) with increasing separation capability. The series of increasingly selective filtration membranes (also referred to as a cascaded filter) helps reduce the osmotic pressure threshold on each subsequent membrane, including the reverse osmosis membrane, and allow the system to operate more efficiently. Some separation systems may require fewer stages, and other separation systems may require more stages. Those of skill in the art will understand how to design a separation system according to the present invention. For one example of beer production, the separation system 2000 may use a first, second, and third membranes 2110/2120/2130 that comprise nano-filtration membranes to remove substantially larger molecular weight compounds, and a final reverse osmosis membrane 2140 to polish the finished permeate by rejecting smaller molecular weight compounds. In another embodiment, the first, second, and third membranes 2110/2120/2130 may provide the same level of filtration or may provide increasingly selective filtration. While nano-filtration membranes are a preferred embodiment, ultra-filtration membranes may also be used as one, multiple, or all filters in the cascaded filter. For another example of beer production, the separation system 2000 may use two filtration membranes—first 2110 and second 2120 nano-filtration membranes—and a final reverse osmosis membrane 2140. The final permeate (substantially comprised of water and alcohol) exits the permeate output 2400 while the retentate from each cascaded filter stage (2110, 2120, 2130, etc.) is preferably combined and passed through a retentate output 2300. In other embodiments, the retentate from each filter stage could be fed to a separate retentate output, or cycled internally through the separation system. Eventually, however, the purpose of the separation system is to separate the retentate and permeate and use the retentate for nested fermentation. Those of skill in the art will understand from the present disclosure that other variations are possible.

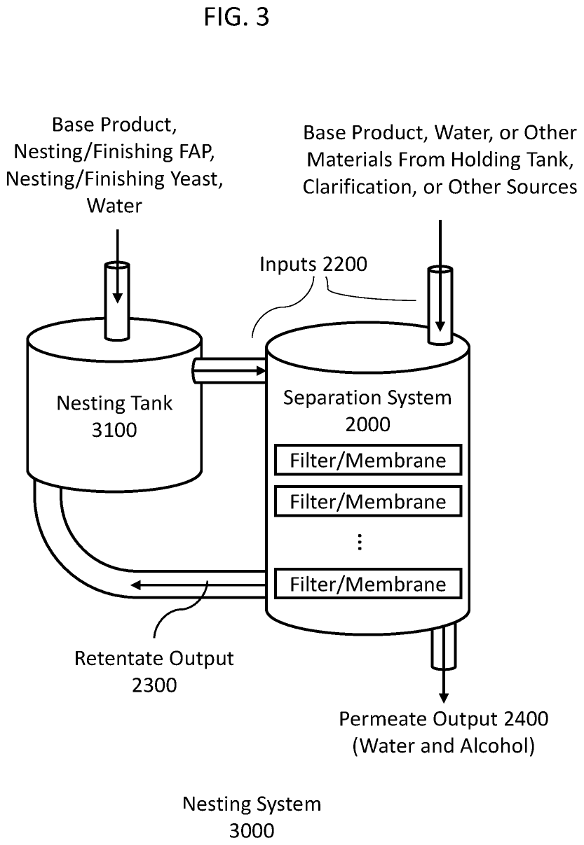

FIG. 3 provides a high-level depiction of an embodiment of a nesting system 3000 consistent with embodiments of the present invention. As shown, the nesting system 3000 comprises a nesting tank 3100 and a separation system 2000. As shown in FIGS. 2 and 3, and discussed herein, the separation system 2000 may have one or more input(s) 2200 for nesting solution, water, FAP, and/or other materials. In a preferred embodiment, materials such as the base product, nesting/finishing FAP, nesting/finishing yeast, and water are added to the nesting tank and then the mixed nesting solution is taken from the nesting tank 3100 and passed to the separation system 2000. In addition, it is advantageous to design the nesting system 3000 to minimize passing larger materials from the nesting tank 3100 to the separation system 2000.

Although shown as a tank, the nesting tank 3100 is not required to be a separate chamber. For example, in one embodiment, the nesting tank 3100 may comprise the pathway (e.g., tubing or piping) between the retentate output 2300 and an input 2200. If the pathway (e.g., tubing or piping) can contain a sufficient volume of material it can serve as a “nesting tank” 3100 despite the fact that it is not a separate physical tank-like chamber. As discussed herein, a tank like chamber is preferred for the nesting tank 3100 in order to make it easier to combine materials. In addition, nothing in the present invention limits using multiple tanks, pathways (e.g., tubing or piping pathways) as the nesting tank 3100.

During the concentration phase 1410, as the retentate is returned to the nesting solution, the overall concentration of the nesting solution will increase. Depending on the desired level of concentration, only a portion of the nesting solution may need to be passed into the separation system, or the nesting solution (including any retentate returned to the nesting solution) may need to be cycled through the separation system once (or more than once) in order to reach the desired level of concentration. When referring to the concentration of the nesting solution, generally a person of skill in the art is referring to the concentration of the nesting solution in the nesting tank at any given period of time.

### Water Nest

In the present invention, it may be preferable to further decrease the alcohol by volume (ABV) of the nesting solution before adding additional fermentation ingredients. Because many separation systems operate at an equilibrium, it may be desirable to perform a water nest 1420 where water is added to the nesting solution as it is cycled through the separation system 2000. By adding water to the nesting solution, this allows the system to reduce the ABV for a given concentration level.

Notably, there is not a required order of the concentration phase 1410 and water nest 1420. Indeed, the concentration phase 1410 may precede the water nest 1420, follow the water nest 1420, or be performed at the same time as the water nest 1420. For example, the water nest 1420 and concentration phase 1410 may be performed at the same time by adding less water than what is required to maintain a constant concentration, but still assist with reducing the overall ABV of the nesting solution. In this way, the concentration may increase slower than it would if no water was being added, while the ABV may drop more than it would have if no water had been added, allowing the nesting solution to reach a desired concentration and desired ABV at approximately the same time.

One aspect of the present invention is controlling the ABV so that it remains sufficiently low while the concentration of the nesting solution is increased. In particular, the ABV is controlled to ensure that any ingredients that are not soluble in alcohol (such as many proteins and carbohydrates) do not fall out of solution/suspension. For the example of making beer, certain beers (such as stouts, wits, porters, and ales) may have higher amounts of proteins and carbohydrates. If the concentration is increased before the alcohol by volume is sufficiently decreased, the nesting solution may experience shear thickening within the separation system. By decreasing the ABV while the concentration is increased, this shear thickening effect can be reduced or prevented.

Although not required by the present invention, it is preferred that at the end of any concentration phase 1410 and water nest 1420, both the concentration and ABV of the nesting solution be lower than for the desired final fermented beverage concentration. This is because in the next phases of the nesting process, additional fermentation ingredients are added that will both increase the overall concentration of the nesting solution and increase the alcohol content of the nesting solution.

### FAP Nest and Finishing Nest

In order to further increase the concentration of the nesting solution, the present invention uses nested fermentation where additional fermentation ingredients, including nesting FAP and nesting yeast, are added to the nesting solution. This is shown with the FAP nest 1430 and finishing nest 1440. Although the concentration of the nesting solution has been increased, lowering the ABV of the nesting solution allows for nested fermentation in the concentrated solution.

The FAP nest 1430 and finishing nest 1440 allow for the density of the nesting solution to increase while also adding the desirable ingredient based finishing attributes, that contribute taste, aroma, and mouth feel.

The FAP nest 1430 and finishing nest 1440 may be performed as separate steps or part of the same step. The FAP nest 1430 refers generally to the period where the nesting solution continues to be cycled through the separation system as nesting ingredients are added, and/or after the nesting ingredients are added. Likewise, the finishing nest 1440 refers to the period where any retentate from the separation system is returned to the nesting solution and subsequent fermentation and/or final ingredient addition is supported. Fermentation during the finishing nest 1440 may be desirable because it will help consume certain undesired remaining ingredients, such as oxygen, and will also continue to enhance desirable attributes, such as flavor, aromatics, and mouth feel.

As discussed herein, performing the FAP nest 1430 is not essential or required. Indeed, those of skill in the art after having the benefit of the present disclosure will understand that continuing to cycle the nesting solution through the separation system as or after nesting ingredients are added is not required.

The FAP nest 1430 and/or finishing nest 1440 should be controlled such that the final alcohol by volume (ABV) and final concentration are achieved. This is done by adding the proper amount of nesting ingredients (e.g., nesting FAP and/or finishing FAP) to achieve the final ABV and final concentration.

### Additional Modifications and Variations

After having the benefit of the present disclosure, those of skill in the art will realize numerous modifications that can be made consistent with the present invention. Further details regarding certain modifications mentioned above are provided below.

### Alternative (Specialty) Yeast Strains in Final Ferment

As earlier stated, the flavors and aromatic profile associated with the volatile compounds produced during fermentation are far less critical for the first ferment. This means that the beverage producer can preferentially select a strain of yeast based upon performance characteristics (e.g., attenuation, alcohol tolerance, economics, availability) for the first ferment rather than a yeast that is required to deliver a specific character. While the flavor and aroma profile provided by the yeast may be less important the first ferment, it is often more important to the finishing character of the finished fermented beverage. If the finished fermented beverage requires a specific strain of yeast in order to align with a specific style, then that strain of yeast should be used for the final ferment(s). For example, if the final finished beverage is a Belgian style ale, then an appropriate Belgian style strain of yeast should be used to produce and yield the appropriate flavor and aroma qualities associated with a Belgian style ale. Since the final ferment is typically a reduced volume as compared to the initial ferment and there is often less total sugar to be metabolized in the final ferment, that means that less total yeast is required for the final ferment. The brewer can therefore utilize an economically beneficial and readily accessible yeast for the initial ferment(s) where derived yeast flavor and aroma are less critical, and utilize a reduced quantity of specialty yeast on the final ferment to achieve the specialty yeast profile for the finished beverage. This results in economic savings and supply chain efficiencies for the brewer who must manage yeast viability and availability.

### Alternative Fermentable Products for Additional Nested Fermentation

It is common for the FAP nest 1430 and/or finishing nest 1440 to require additional processing time, energy, and resources in both FAP production, as well as additional time processing through the separation system. It is therefore advantageous to be able to support additional ferments and achieve the benefits of those additional ferments (as already described in this application) without having to invest additional preparation and production time, ingredients, and resources into building and conducting the FAP.

One solution is to build the base FAP for the base fermentation 1200 so that the base product embodies the appropriate and desired profile for what will become the finished beverage. Then, for purposes of all subsequent nested fermentation use more efficient (either operationally and/or economically) fermentable products to support the FAP nest 1430 and/or finishing nest 1440.

One example of alternative fermentable products are brewers crystals. Brewers crystals could be used in brewing beer, kombucha, and other beverages in order to reduce costs and/or improve efficiency. In a preferred embodiment, brewers crystals may be homogenously dissolved into an appropriate amount of water (to create an aqueous version) to then allow the easy blending of that liquid into the nesting tank. The brewers crystals may also be added directly to the nesting tank. Although not “aqueous” in form, a person of skill in the art would understand brewers crystals that are added directly to the nesting tank to correspond to the FAP as described herein. The amount of brewers crystals to use will be well understood by those of skill in the art. The amount of brewers crystals used is the amount needed in order to achieve the desired sugar concentration in the FAP to achieve the desired finished ABV of the finished fermented beer.

Brewers crystals are a blend of common and readily fermentable sugars known to brewers, but other sources of fermentable sugars could also be used. For example, for wine production, the alternative FAP could be comprised of concentrated grape juice or alternative sugars. For the example of kombucha production, the alternative FAP could be comprised of fermentable sugars in or out of solution. In addition, multiple sources of readily fermentable sugars could be blended or mixed together. Some examples of other sources of fermentable sugars includes dry malt extracts, liquid malt extracts, and refined or natural sources of sugars. This concentrated sugar addition therefore can be added directly to the concentrated nested product to support subsequent nested ferments without undergoing the wort nest phase of the process.

### Spent-Dry-Hop Rinsing

It is commonly understood by brewers that adding hops to a beer that is either fully fermented or still fermenting can impart highly desirable flavor and aroma qualities to a finished beer. Prior to final packaging the dry (vegetative) hops must be removed. This removal is typically done by decanting the liquid that is sitting above the settled vegetative hops, centrifuge, filtration, or a combination of these techniques. Regardless of which techniques are used, when discarding the spent hops, the brewer also loses the beer that is soaked into those hops. This results in a reduced yield and has negative economic impact on the brewer. It is therefore desirable to reduce the loss of beer caused by discarding the beer-soaked hops after dry-hopping. This concerning effect is amplified in the case of dry-hopping a concentrated beer such as beer produced with nested fermentation because the loss of beer soaked into the hops ultimately represents even more finished product. Thus for traditional brewers and especially for brewers who are producing a concentrated beer, finding a solution to reduce beer loss through dry-hopping is advantageous.

The dynamics of managing concentrated beer offers a novel solution to this concern. In the case of concentrated beer, the spent hops can be rinsed once or multiple times with water that then gets blended into the finished beer prior to packaging. Concentrated beer already requires a water addition step to “dilute” the beer to a normal consumable concentration level. By first using this water to “rinse” the hops, the brewer is able to recover significant amounts of otherwise lost beer that is soaked into the spent hops.

While this solution is uniquely appropriate in the case of concentrated beer because concentrated beer requires a final water addition prior to packaging, a traditional brewer can also take advantage of this solution by brewing their beer as a “high-gravity-beer” where that beer is brewed to a strength greater than the final strength of the beer that will be packaged. The water used for the dilution which is required to make this adjustment to the final beer strength can first be used to rinse the spent-dry-hops and recover significant quantities of otherwise lost beer.

### Depicted Embodiments

Without limiting the present invention, the following provides discussion of the depicted embodiments consistent with the written description herein.

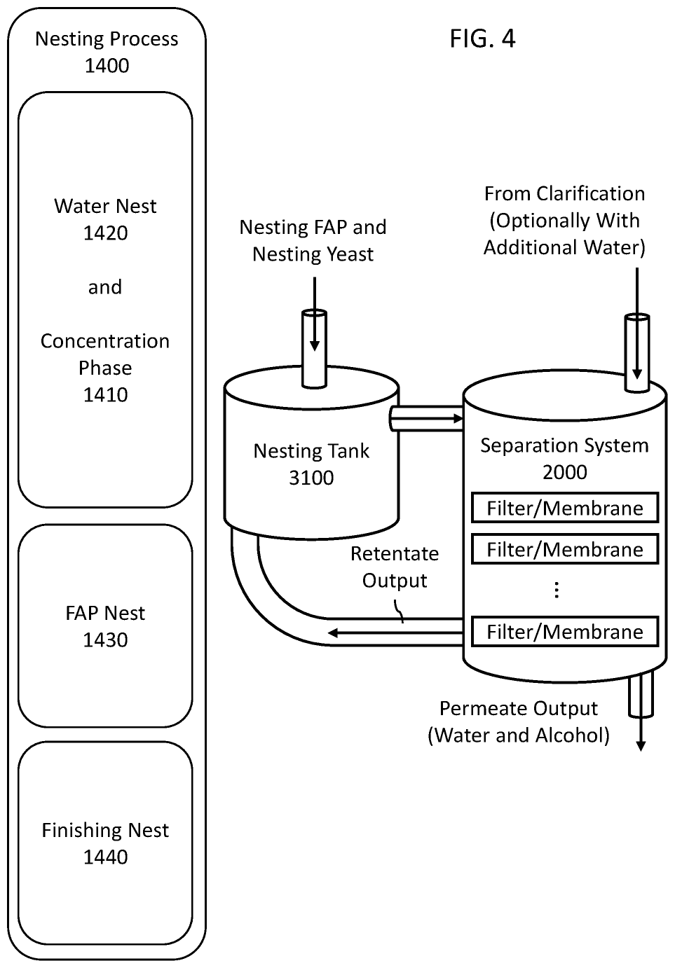

FIG. 4 depicts an embodiment where the base product output of the clarification process 1300 is (optionally combined with water and then) passed directly into the separation system 2000. Accordingly, the retentate that first enters the nesting tank 3100 has already undergone some amount of a water nest 1420 and concentration phase 1410. Once the nesting solution (in this case, retentate from the separation system 2000) enters the nesting tank 3100 it is combined with nesting FAP and/or nesting yeast in order to allow for nested fermentation. The nesting solution is then passed back to the separation system 2000 (with or without additional water) until the desired concentration and ABV has been reached. Those of skill in the art will recognize that in this embodiment (as in others) nesting solution from the nesting tank (which is a nesting solution that comprises retentate from the separation system) can simultaneously be input to the separation system 2000 while base product (optionally combined with water) continues to be input into the separation system 2000.

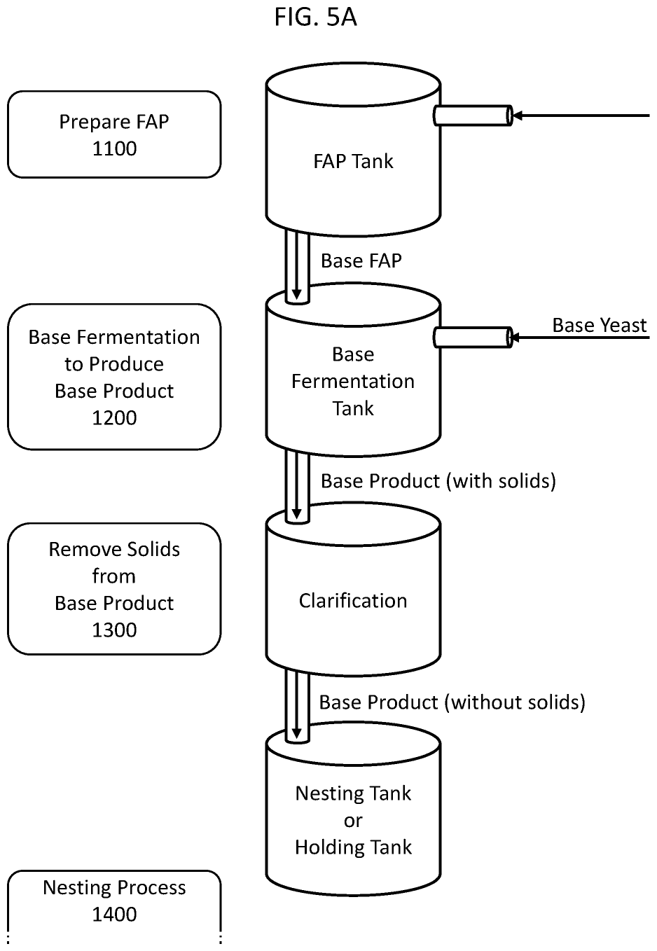

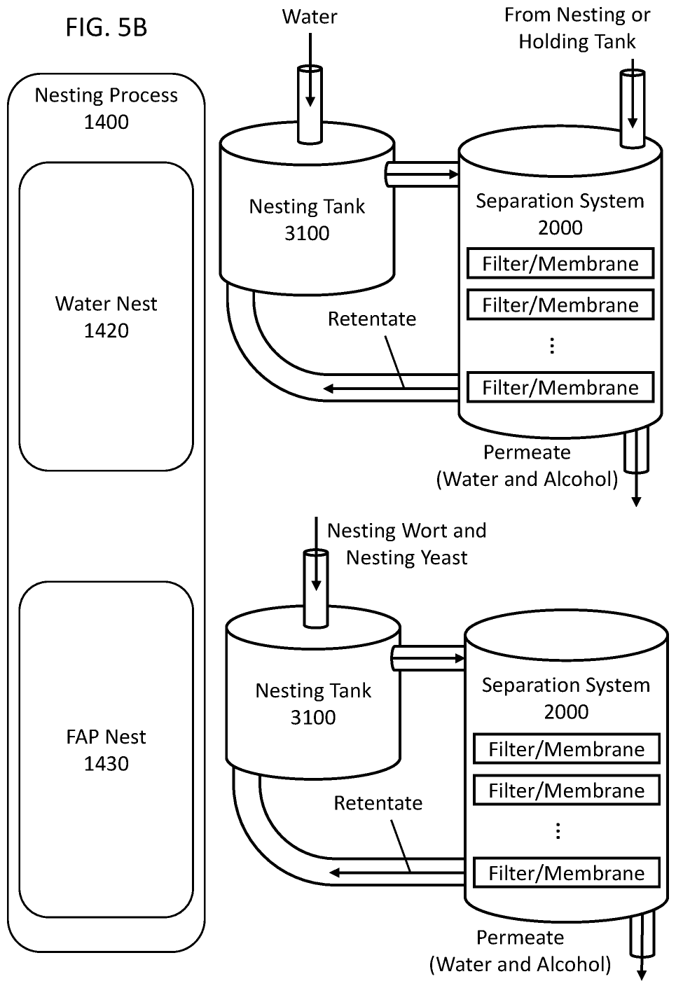

Turning now to FIGS. 5A and 5B, these figures show yet another embodiment consistent with the present invention and prior description. In this embodiment, the preparation of the base product (without solids) follows the same general steps as described previously for FIG. 1. This embodiment, however, shows in FIG. 5B that only two phases of the nesting process 1400: a water nest 1420 and a FAP nest 1430/1440. In this embodiment the water is added directly to the nesting tank 3100 before or while the nesting solution is passed to the separation system 2000. Accordingly, there is no separate concentration phase. By controlling how much water is added to the system, at what rate, and at what time periods, those skilled in the art will be able to control exactly what the concentration and ABV are in the nesting solution at all times. In this embodiment, a FAP nest 1430 is used in order to perform the nested fermentation and control the concentration, ABV, and other characteristics (flavor, taste, mouth feel, etc.) of the nesting solution. Although not shown directly, this embodiments provides for the possibility that at some point the retentate from this system could be sent a separate tank for the finishing fermentation 1440. Or, alternatively, the nesting solution in the nesting tank could be passed to a separate tank/chamber for the finishing fermentation—or to multiple separate tank/chambers for the finishing fermentation. This may have operational or logistic benefits and is well within the scope of the present invention.

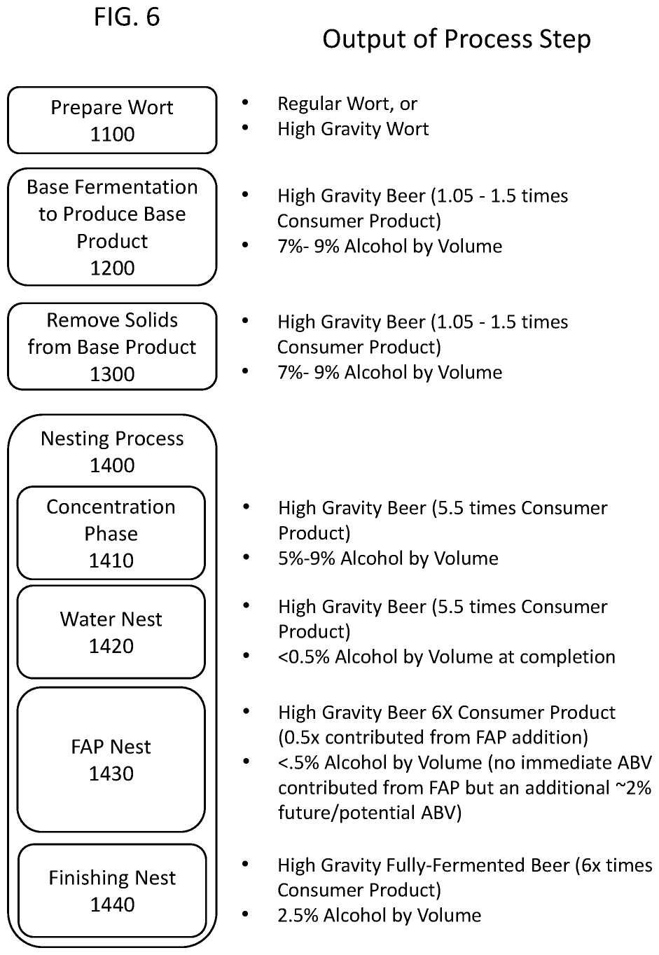

Turning now to FIG. 6, purely for exemplary purposes—and without intending to limit the present invention—this provides an example of the “output” of each process step for an exemplary beer brewing embodiment. The word “output” is used broadly because, as is clear the disclosure herein, there is not a formal “output” to many of the process steps described herein. The purpose of providing this example is to teach how the various process steps might be controlled to get to a final high gravity beer that is approximately 6 times more concentrated than the consumer product (e.g., 12 oz of the concentrate is capable of being mixed with carbonated water to produce six-12 oz beers for consumption).

In the exemplary embodiment in FIG. 6 a wort is used to produce a high gravity beer during the base fermentation 1200. After solids are removed (1300), a nesting process 1400 is used to perform nested fermentation. A concentration phase 1410 can be used to substantially increase the concentration (or gravity) without substantially increasing (and potentially even decreasing) the ABV. A water nest 1420 is then used to reduced the ABV. The FAP nest 1430 can make a small increase to the concentration (or gravity) almost immediately, but without necessarily largely increasing the concentration thereafter. During the FAP nest 1430, the ABV doesn't immediately increase, but available sugars can contribute to an increase of around 2% after the FAP nest is complete. And finally, during the finishing nest 1440 the fermentation ingredients are all allowed to process to finish off the beer and obtain the desirable characteristics discussed above.

In this embodiment the concentrate has an ABV of 2.5%, which once diluted to a drinkable beer corresponds to an ABV of less than 0.5%. Once again, the concentrations and ABVs after each stage are not limiting. Instead, this is solely provided in order to assist a person of skill in the art in obtaining the benefit of the present disclosure.

Those skilled in the art can readily recognize that numerous variations and substitutions may be made in the invention, its use and its configuration to achieve substantially the same results as achieved by the embodiments described in the appendix.

In conclusion, the present invention provides, among other things, a system and method for producing improved fermented beverage concentrate. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

1. A method for producing a fermented beverage concentrate, the method comprising:
fermenting a first fermentable aqueous product to produce a base product; and
performing a nesting process on the base product, wherein the nesting process comprises:
a water nest wherein water is added to at least a portion of the base product and passed through a separation system to produce a nesting solution, and
a fermentable aqueous product nest wherein a second fermentable aqueous product is added to at least a portion of the nesting solution and passed through the separation system to increase the concentration of the nesting solution.

2. The method of claim 1, wherein performing the nesting process further comprises:
a finishing nest wherein fermentation ingredients are added to the nesting solution without further passing the nesting solution through the separation system.

3. The method of claim 2, wherein fermenting the first fermentable aqueous product comprises using a first yeast and wherein the finishing nest comprises using a second yeast, wherein the first yeast and second yeast are different.

4. The method of claim 1, wherein performing the nesting process further comprises:
a concentration phase wherein at least a portion of the nesting solution is passed through the separation system to increase the concentration of the nesting solution.

5. The method of claim 1, further comprising:
removing solids from the base product prior to the nesting process.

6. The method of claim 1, wherein the first fermentable aqueous product comprises a first wort and the second fermentable aqueous product comprises a second wort that is different from the first wort.

7. The method of claim 1, wherein the base product has a density that is 1.25-1.75 times the desired density of a final consumed product.

8. The method of claim 2, wherein the fermentation ingredients comprise fermentable aqueous products and yeast.

9. The method of claim 1, wherein the first fermentable aqueous product comprises a first wort and the second fermentable aqueous product comprises brewers crystals.

10. (canceled)

11. A method for producing a fermented beverage concentrate, the method comprising:
performing a first fermentation to produce a nesting solution;
reducing the alcohol by volume (ABV) of the nesting solution, wherein reducing the ABV comprises forming a first combined solution by combining at least a portion of the nesting solution with water, passing the first combined solution through a separation system and returning the retentate to the nesting solution; and
increasing the concentration of the nesting solution, wherein increasing the concentration comprises forming a second combined solution by combining at least a portion of the nesting solution with a fermentable aqueous product, passing the second combined solution through the separation system and returning the retentate to the nesting solution.

12. The method of claim 11, wherein performing the nesting process further comprises
adding fermentation ingredients to the nesting solution without further passing the nesting solution through the separation system.

13. The method of claim 11, wherein performing the nesting process further comprises
passing at least a portion of the nesting solution through a separation system and returning the retentate to increase the concentration of the nesting solution.

14. The method of claim 11, wherein the fermentable aqueous product comprises one of wort, must, sweetened tea, or brewers crystals.

15. The method of claim 11, wherein reducing the ABV of the nesting solution comprises reducing the ABV to 1% or lower.

16. The method of claim 11, wherein reducing the ABV of the nesting solution comprises reducing the ABV to 0.5% or lower.

17. The method of claim 11, wherein increasing the concentration of the nesting solution comprises increasing the concentration of the nesting solution to greater than 5.0 times the concentration of a desired concentration of a final consumed product.

18. The method of claim 12, wherein the fermentation ingredients comprise fermentable aqueous products and yeast.

19-26. (canceled)
